(19) United States
(12) Patent Application Publication
(10) Pub. No.: US 2004/0009277 A1
(43) Pub. Date: Jan. 15, 2004

(54) Method of preparing food products and food intermedates having beneficial hypocholesterolemic activity

(76) Inventors: Ronald A. Heddleson, Plymouth, MN (US); Timothy O. Hansen, Coon Rapids, MN (US)

Correspondence Address: GENERAL MILLS, INC., P.O. BOX 1113, MINNEAPOLIS, MN, 55440, US

(21) Appl. No.: 10/192,351

(22) Filed: Jul. 9, 2002

(51) Int. Cl. A21D 10/00

(52) U.S. Cl. 426/549

(57) ABSTRACT

A food product and food intermediate, and method of creating a food product and food intermediate having beneficial hypocholesterolemic activity, wherein a source of beta glucan is added to the food compositions after at least some of the other ingredients of the food composition have already been combined and mixed for a first period of time to form an intermediate composition. The addition of the source of beta glucan later in the production of the food composition has been found to increase the processability of such food compositions while maintaining the healthy benefits associated with such additions.

### CROSS-REFERENCES TO RELATED APPLICATIONS

None.

### FIELD OF THE INVENTION

The present invention relates to food products and food intermediates that have beneficial hypocholesterolemic activity and methods for the producing such food products and intermediates. More specifically, the invention relates to food products and intermediates having increased levels of soluble dietary fiber (particularly a concentrated source of beta glucan) as well as the unique method of handling such food products and intermediates that resolves difficulties encountered in processing such material or ingredients.

### BACKGROUND OF THE INVENTION

There is a large amount of information in circulation today concerning elevated cholesterol levels and the health consequences due to that condition. In an effort to combat this result, a number of pharmaceutical applications, dietary supplements and other solutions relating to the treatment of high cholesterol levels have been previously introduced. However, regrettably, many of these products have an unpleasant mouth feel, that is they can feel slimy, have a displeasing taste or result in undesirable side effects which diminishes their overall value to the intended end user.

In addition, there also appears to be a growing disdain against ingesting some sort of dietary supplement, pharmaceutical treatment or other product to attain some perceived beneficial effect from such products. This may be due to a growing reliance on pills or tablets to sustain or maintain our health. Such reliance on supplements may also surprisingly contribute to malnutrition as other valuable vitamins and minerals can be omitted or overlooked when too much focus is diverted to certain items. Moreover, certain supplements may actually remove valuable macronutrients and micronutrients from the system. Individuals may also be concerned with potential risks and side effects associated with certain medications, treatments or supplements. In fact, dietary restrictions and other health concerns may preclude certain portions of the population from even consuming such products. As such, there remains a continuing interest in developing good tasting, well balanced, food products that contribute to a well balanced diet as well as provide a vehicle by which to deliver the benefit of cholesterol reduction in a palatable and efficient manner to meet the changing needs of the population.

Cholesterol in humans is known to come from primarily two sources, the body's own production of cholesterol (endogenous) and dietary cholesterol (exogenous). Lipoproteins contain specific proteins and varying amounts of cholesterol, triglycerides and phospholipids.

Bile acids are synthesized from cholesterol in the liver and then secreted into the intestines. Reducing the level of bile acid reabsorption facilitates the maintenance of a healthy cholesterol level. One method for reducing bile acid reabsorption is achieved by increasing the gut viscosity. Alternatively, a non-digestible dietary component which binds bile acids secreted in the proximal jejunum will reduce bile acid reabsorption in the lower intestines (distal ileum).

There are three major classes of lipoproteins and they include very low-density lipoproteins (“VLDL”), low density lipoproteins (“LDL”) and high density lipoproteins (“HDL”). The LDLs are believed to carry about 60-70% of the serum cholesterol present in an average adult. The HDLs carry around 20-30% of serum cholesterol with the VLDL having around 1-10% of the cholesterol in the serum. To calculate the level of non-HDL cholesterol present, that is to find the level of LDL or VLDL levels, which indicates risk; the HDL is subtracted from the total cholesterol value.

Typically, the average person consumes between 350-400 milligrams of cholesterol daily, while the recommended intake is around 300 milligrams. Increased dietary cholesterol consumption, especially in conjunction with a diet high in saturated fat intake, can result in elevated serum cholesterol. Having an elevated serum cholesterol level is a well-established risk factor for heart disease and therefore there is a need to mitigate the undesired effects of cholesterol accumulation. High cholesterol levels are generally considered to be those total cholesterol levels at 200 milligrams and above or LDL cholesterol levels at 130 milligrams and above. By lowering the total system LDL cholesterol level, it is believed that certain health risks, such as coronary disease and possibly some cancers, that are typically associated with high cholesterol levels, can be reduced by not an insignificant amount.

Numerous studies relating to modifying the intestinal metabolism of lipids have been done to illustrate that such effects can reduce a high cholesterol level. Hampering the absorption of triglycerides, cholesterol or bile acids or a combination of these items results in a lowering of cholesterol levels in the serum.

Soluble dietary fiber is known to be a safe ingredient due to its long history in food supply. Soluble fiber typically remains undigested, except by colonic microflora present in the lower intestines. Soluble dietary fiber is believed to have a beneficial effect in the reduction of high serum cholesterol levels and reducing the risk associated with such elevated levels. In addition, soluble dietary fiber can have the additional beneficial effect of reduced constipation, improved regularity and for the regulation of the glycaemic response associated with the digestion of many substances. However, too much fiber in the diet can create undesirable gastrointestinal side effects such as flatulence, diarrhea, and abdominal cramps, etc. leading consumers to stay away from food products that contain too much dietary fiber, regardless of any associated health benefits. While some consumers may not completely avoid such products, they also do not typically regularly use such products due to the problems enumerated above or alternatively, or in combination due to the unpleasant taste of such products. This illustrates some of the problems with prior solutions that were aimed at providing high fiber diets directed at lowering cholesterol levels, and highlights the need to create a more balanced solution that fits not only within more normal dietary patterns but also meets consumer demand for better tasting, healthy products.

Beta glucans are useful as soluble dietary fibers. Food products high in soluble fiber are generally considered to be healthful foods and food ingredients. The food product of the present invention provides beneficial hypocholesterolemic activity through increased bile acid binding activity while simultaneously delivering a food product which is not adversely affected by the inclusion of increased levels of soluble dietary fiber, either in taste or texture or in any undesirable side effects.

Beta glucans are particularly useful as food ingredients because they have neutral flavors and provide bulk in addition to having desirable mouthfeel and texture characteristics. However, too much beta glucan in a product can give the product a “gummy” or slimy taste and texture and as such, to date only low levels of beta glucans have been added to food products. The term “low levels” refers to an amount generally less than 1 gram in a 30-gram serving or about 3% or less by weight.

The presence of only low-level beta glucan is due in part to a number of difficulties in adding beta glucan into foods, particularly processed foods, for example grain based products and food intermediates such as dough.

If the beta-glucan concentrate is added with the other dry ingredients, the resulting dough exhibits significant problems with mixing and processing. These attributes cause significant problems with mixing and processing the dough. The first step in finding a solution to this problem was to reduce the amount of water added, however, this did not result in an optimal solution.

One prior art solution directed at avoiding the addition of dietary during mixing is found in U.S. Pat. No. 5,188,860. Here, the fiber is mixed with the dough during the pelletization stage of the formation. The pelletization step comes after the cooking and tempering of the dough and then the pellets are formed into flakes or other shapes. However, applicant's have found that this may not result in an adequately mixed product or alternatively, the fiber may stick to the rollers or other apparatus forming the flakes defeating the purpose of incorporating the fiber into the mixture.

Beta glucan, when hydrated, becomes very viscous and causes the dough to become slimy and unextrudable, which makes it difficult, and sometimes impossible to handle in various processing applications. For example, in attempting to make ready to eat (RTE) cereals using a grain based dough, it has been found that when a concentrated source of beta glucan is included along with the other dry ingredients and then the ingredients are mixed with water to make the dough, the dough rapidly becomes viscous and cannot be processed properly. The dough will cling to the mixing apparatus causing the apparatus to become unbalanced and generating additional wear and tear on the machine. In addition, this unbalancing does not permit the ingredients to be thoroughly mixed or hydrated. This is due to the preferential hydration of beta glucan and hence heretofore why only small amounts of beta glucan, despite the beneficial attributes of the ingredient, have been able to be added to food products.

Thus, there is a need to develop a process by which increased levels of beta glucan can be included in the food compositions to form intermediates such that the intermediates and products can maintain a high degree of processability and facilitate handling as with traditional food intermediates.

All publications, patents and patent applications are incorporated herein by reference.

### BRIEF SUMMARY OF THE INVENTION

In exemplary embodiments of the present invention, a concentrated or purified source of beta glucan is incorporated into compositions to form food intermediates in a manner that allows the food compositions and intermediates to be processable. As contemplated herein, a concentrated source of beta glucan is added to the food compositions after at least some of the other ingredients of the food composition have already been combined and mixed for a first period of time to form at least a first intermediate composition. The addition of a concentrated source of beta glucan later in the “cook” has been found to decrease the processing difficulties of the food intermediates that have increased levels of beta glucan.

The method of the invention is particularly suitable for the inclusion of a concentrated source of beta glucan into food intermediates such as dough, and the subsequent processing to yield finished consumer products such as ready to eat cereal, ready to eat meals, cake and baking mixes, breads, rolls, biscuits, waffles, snack, crackers, cereal bars, extruded snacks, pies, toaster pastries and the like.

In one embodiment of the present invention a method of preparing a food intermediate, the method is described and comprises initially providing a first group of ingredients in a first state or condition. This condition is usually dry or dehydrated. Then a first food intermediate is formed by combining the first group of ingredients together. The first food intermediate is created through at least partial hydration and mixing of the ingredients for a first period of time and provides an intermediate having a second state that is different from the first. Then a concentrated source of beta glucan is added to the first food intermediate to create a second food intermediate that is distinct from the first food intermediate. The second food intermediate is mixed for a second period of time, that is less than the first period of time to complete the formation of a final intermediate.

In a further embodiment of the present invention a method of preparing a food intermediate having increased levels of dietary fiber is described and comprises the steps of initially providing a first group of ingredients and then mixing the first group of ingredients for a first period of time to produce a first food intermediate. Then a concentrated source of dietary fiber is added and mixed with the first intermediate for a second period of time to produce a second intermediate. The second period of time is less than said first period of time.

In a still further embodiment of the present invention a food intermediate formed from at least two distinct mixing steps, comprises a first group of ingredients mixed for a first period of time to form a first food intermediate having a first texture. A concentrated source of beta glucan is mixed with the first food intermediate during a second period of time, that is less than the first period of time to create a second food intermediate. The second food intermediate having a texture distinct from said first texture and said second food intermediate having greater than 5% by weight of beta glucan.

These and other objects of the invention will become clear from an inspection of the detailed description of the invention and from the appended claims.

### DEFINITIONS

The term food “intermediate” as used herein refers to at least one intermediate that undergoes a further processing step, such as baking, mixing, etc. before the final food product is formed. In food processing, one or more intermediates may be formed.

The term “cook” as used herein refers to the steps of mixing, combining, processing, kneading, heating and/or cooking which may occur in any order or sequence and in combination with one another.

As used herein “concentrated” or “purified” refer to higher level of beta glucan being present in the milling fraction and are intended to be used interchangeably. The percentages by weight of beta glucan range from 5 to approximately 80%.

### DETAILED DESCRIPTION OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The soluble fiber component of the present invention may be derived from a number of grains and are composed of generally long chain polysaccharides having a variety of structures. As stated previously, soluble fiber is generally resistant to human digestive enzymes, except for colonic microflora present in the lower intestines, and are known for their water and ion-binding capacity. For the present invention, the concentrated source of beta glucan may include between 5 to 80% by weight beta glucan. In other embodiments, the concentrated source of beta glucan includes between 5 to 50% beta glucan and more preferably, the range of beta glucan as used in the present invention includes at least about 5 to 25% by weight beta glucan.

Psyllium, as used in the present invention, is a known mucilaginous material derived from seeds from the plants of the Plantago genus, Plantago ovata, found in sub-tropical areas. The seeds are dark and shiny and have something of a concave shape to the exterior. Psyllium has been regularly used as a laxative to promote regular bowel function. Psyllium seed may be used in ground, dehusked or in whole form and represents a source of soluble dietary fiber. However, psyllium can have a coarse or rough texture making ingestion occasionally difficult, if the fiber component is not processed in a manner making it readily useable in a consumer food product.

Oat flour as used in the present invention is essentially heat-treated oat groats (hulled, crushed oats) or rolled oats that are ground on a hammer mill or other smooth rolls. There is no separation of the components during the processing of the flour.

Oat bran as used in the present invention is produced by grinding clean oat groats or rolled oats and separating the resulting flour by suitable means, such as sieving, into fractions such that the oat bran fraction is not more then 50% of the original starting material. The separated fraction should have at least 5.5% of beta glucan (dry weight basis), and a total dietary fiber content of at least 16% (dry weight basis), so that at least one third of the total dietary fiber is soluble fiber.

Barley, as used in the present invention, is processed in a manner that resembles oats as set forth above, in that it consists of cleaning, hulling, sieving and then grinding. Waxy hulless barley has a higher dietary fiber content than most other sources of fiber and can range from 14 to 20% of the dry weight and have a beta glucan content of around 8 to 10%.

Guar gum is produced from the guar plant Cyanaposis tetragonolobus by milling the endosperm after removal of the hull and germ. Guar gum is a galactomannan with liner chains of D-mannopyranosyl units having side branching units of D-galactopyransose attached by (1→6) linkages. Guar gum has good water binding properties facilitating its use in food products.

Beta glucans, particularly mixed linked grain beta glucans (oats and barley), are a known source of dietary fiber and have been included in food products that are used in weight control (beta glucans used as fat substitutes) and as cholesterol lowering additives. Beta glucans are obtained from milled cereal grains such as oats and barley (waxy, hulless barley being a particularly good source) in a manner discussed above and are then extracted from the milled grains into warm water and then the solids are removed from the solution.

Beta glucan is a naturally occurring polysaccharide that can be found, in the cell walls of cereal grains. Beta glucan, or beta 1-4/1-3 glucosyl pyranose polymer, is a chain of (1-4) and (1-3) linked glucose molecules that is staggered, having a beta (1-3) linkage after 4-6 beta (1-4) linkages. This results in a laminated macromolecule. This general beta glucan structure will continue for 20,000 to 100,000 glucose units. The laminations allow water molecules to fit between the beta (1-4) layers which allows beta glucan to hydrate.

It has been discovered that another problem associated with the addition of long chain beta glucans early in the blending of the ingredients is that the long chain beta glucans are subjected to the full range of processing steps resulting in shearing of the chains. That is, due to contact with the mixing apparatus, shearing reduces the length of the chain, which may reduce some of the beneficial hypocholesterolemic activity of the beta glucan.

The beta glucans that are used in this invention can be naturally occurring or be chemically or enzymatically modified by altering the specific linkages. Methods for extracting and purifying beta glucan, for example, from the cell walls of cereal grains, have been developed and an exemplary method is described in commonly assigned application Ser. No. 10/067,016 filed Feb. 4, 2002 the disclosure of which including that found in the claims is incorporated herein by reference.

One commercial source for which a concentrated source of beta glucan can be obtained and used for the present invention is available from Nurture, Inc. of Missoula, Montana and marketed under the trade names NURTURE 3500, NURTURE 5000 or NURTURE 6000.

While addition of the concentrated source of beta glucan into food compositions may be particularly desirable, as discussed briefly above, when such concentrated source of beta glucan is added as a starting or initial ingredient to produce a food composition or food intermediate, such as in the production of a dough, the resulting food intermediate exhibits increased viscosity, stickiness, and ropiness. The resulting food composition is often difficult, and sometimes impossible, to work with and process into a finished food product. The resulting dough may not lend itself to pellatization, and subsequent processing steps such as puffing (to create balls or shaped products) or pressing (rolling) to produce flakes, or even flatten dough to be packaged into chubs and other containers.

Adding the concentrated or purified source of beta glucan to the cook no earlier than half way through the process reduces the amount of hydration of the beta glucan as well as reduces the level of shearing that the beta glucan is subjected. Typically, most of the ingredients (more than 50%) used to produce the food intermediate, are initially mixed for a first period of time to form a first intermediate. At some time during the second half of the cook, the concentrated source of beta glucan is added to the intermediate to form a second intermediate having an increased level of beta glucan and a unique texture.

The texture of the first intermediate created from the blending of the dry ingredients and then hydrating the ingredient is one that slightly tacky to the touch and one which exhibits a bit of moisture or oily feel. The texture of the second intermediate once the concentrated source of beta glucan has been added is a bit more dry than the first texture but still exhibits a slight tackiness.

When referring to a first state herein, the term refers to a relatively dry state, that is when the ingredients of are first blended together before hydration. The second state is after hydration and creates the texture of the first intermediate referenced above.

The invention can be used to increase the level of beta glucan in any number of food intermediates. A great variety of ingredients can be utilized in the production of innumerable food products, and those of skill in the art will recognize that embodiments of the invention are not limited to any particular ingredients. Typically, however, food intermediates such as dough, comprise a mixture of a flour and a liquid component (e.g. water). Such doughs can also optionally include a broad variety of other ingredients, as is generally known (e.g. salt, seasoning, leaving agents, etc.). Dough can be used to make a broad variety of food products, for example, ready to eat cereals, snack foods, breads, rolls, other assorted baked goods, and a variety of other foods.

The flour or meal used in food doughs are preferably grain based flours or meals that contribute to the structure, texture, taste and appearance of the dough. The flour or meal can be based upon a broad variety of grains, for example, oat, wheat, corn, rice, rye, barley, mixtures thereof, and other such flours or meals and mixtures thereof. In some examples, the flour or meal can be de-fatted, but such embodiments are not necessarily preferred. Preferably, the flour or meal is oat, wheat or corn based, for example an oat, corn or wheat flour. More preferably, the oat-based flour is used.

Additional optional ingredients can be used to modify the properties of the dough, such as the taste, texture, structure, and appearance of the dough. Examples of such additional ingredients include fats or shortening agents, surfactants/emulsifiers, hydrocolloids, salts, sugars and other sweeteners, dough developing agents, texture agents, enzymes, fillers, eggs, leavening agents, flavor enhancing additives, coloring additives, nutritional supplements, preservatives, mold inhibitors and other such ingredients.

Preferably, the concentrated source of beta glucan used in the present invention includes between 5 to 80% by weight beta glucan. In other embodiments, the concentrated source of beta glucan includes between 5 to 50% beta glucan and more preferably, the range of beta glucan as used in the present invention includes at least about 5-25% by weight beta glucan.

Representative constituent concentrations for base components of some doughs embodying the invention can be found in Table 1, wherein the values are given in wt. % of the ingredients in reference to the total dough weight (as referred to herein, weight is not calculated on a dry weight basis).

TABLE 1

| Constituent | Preferred Amounts | More Preferred Amounts |
|---|---|---|
| Flour or Meal | 30-90% | 35-70% |
| Water or Milk | 10-50% | 25-45% |
| Beta Glucan | 10-80% | 5-35% |

In an exemplary embodiment of the present invention, the nutritionally complete food product, in this case a ready to eat (RTE) cereal, may include the following micro and macronutrients in connection with about 2-3 grams of beta glucan (roughly 8 to 12%). The serving size is approximately 30 grams. In order to achieve the serving size due to the increase in the weight percentage of beta glucan, a portion of the flour was removed.

Recommended Daily Value (“DV”)

| | |
|---|---|
| Total Fat | 5% |
| Saturated Fat | 3% |
| Cholesterol | 0% |
| Sodium | 10% |
| Potassium | 5% |
| Total Carbohydrate | 14% |
| Dietary Fiber | 10% |
| Protein | 10% |
| Vitamin A | 10% |
| Vitamin C | 70% |
| Calcium | 0% |
| Iron | 80% |
| Vitamin D | 10% |
| Vitamin E | 100% |
| Thiamin | 100% |
| Riboflavin | 80% |
| Niacin | 80% |
| Vitamin B6 | 80% |
| Folic Acid | 100% |
| Vitamin B12 | 100% |
| Phosphorus | 15% |
| Magnesium | 10% |
| Zinc | 80% |
| Copper | 4% |

This example is based on a 2,000 calorie diet and other food products such as cereal bars, fruit snacks, diary and bakery products, baking mixes and ready to eat meals may contain additional vitamins, nutrients and or minerals as well as potentially varying amounts of the macro and micro nutrients set forth in the instant example.

The RTE cereals of the preceding examples are prepared in a conventional manner. This exemplary RTE cereal is in the form of flakes that are created by preparing a cooked cereal dough through known methods and then forming the cooked cereal dough into pellets that have a desired moisture content. The pellets are then formed into wet flakes by passing the pellets through chilled roller and then subsequently toasting or heating the wet cereal flakes. The toasting causes a final drying of the wet flakes, resulting in slightly expanded and crisp RTE cereal flakes. The flakes are then screened for size uniformity. The final flake cereal attributes of appearance, flavor, texture, inter alia, are all affected by the selection and practice of the steps employed in their methods of preparation. For example, to provide flake cereals having a desired appearance feature of grain bits appearing on the flakes, one approach is to topically apply the grain bits onto the surface of the flake as part of a coating that is applied after toasting.

While the foregoing example is directed to the manufacture of flake cereals, it is readily apparent, that the manufacturing method can be modified to produce puffed or extruded cereals as well in which the dough after forming is either fed through an extruder to create the desired shape or in the alternative is forced through a die or orifice to generate puffed cereals. In addition, the present example can be applied to the creation of dough, which is then packaged in a chub or other container for sale direct to the consumer. After the dough is formed in the above example, instead of palletizing the dough is rolled and further formed by die cutting, slicing, etc. and made available for packaging.

As stated previously, the method of the present invention is directed to adding a concentrated source of beta glucan, to a preformed intermediate later in the process of making a food product. The beta glucan is not added as an initial starting ingredient, but rather is added at a time period after the initial starting ingredients are combined. Typically, the additon of the concentrated source of beta glucan occurs after the half way point of the cook and generally not later than the last quarter of time of the cook. The preferred time to add the concentrated source of beta glucan is between about the half way interval to as late as the final quarter of the cook. That is, if the cook is set for an hour, the earliest the concentrated source of beta glucan would be added is at about 30.1 minutes and the latest at about 45 minutes. It has been found that the optimum time to add the concentrated source of beta glucan is at about roughly two thirds of the way through the cook, or in the present example, around the 40-minute interval.

Not only has this discovery proved advantageous in the processing and handling of food intermediates having higher levels of beta glucan, that is, the stickiness of the intermediate is avoided by limiting the hydration of the beta glucan, it has also been surprisingly found that the addition of beta glucan subsequent to the initial blending or mixing of the ingredients minimizes some if not most of the handling associated with beta glucan. Moreover, the addition of beta glucan at a later stage contributes to an improved texture or even a “healthy” or aesthetically pleasing appearance. That is, the fiber for the most part remains in the outer layers of the intermediate giving the product a “healthy” look and upon mastication, the consumer tastes the inner portion of food product formed from the intermediate rather than the outer layer, thereby also possibly avoiding prolonged contact with the heightened level of fiber.

The length of the first period of time, which is the time period prior to the addition of the beta glucan, can vary greatly from one embodiment to the next, depending upon the kind of food composition being produced. For instance, the first time period can range from a matter of seconds, up to a period of days, or potentially more. In certain embodiments, an inventory of the intermediate composition could be created and stored for a long period of time prior to the addition of the beta glucan to the intermediate composition.

In the preparation of some food products, the cook period ranges from about 30 seconds to about 3 hours, more preferably from about 1 minute to about 2 hours, and most preferably from about 20 minutes to about 1 hour.

In one embodiment, the composition is mixed for a second period of time starting on or slightly after the addition of the beta glucan. The length of the second period of time can vary greatly from one embodiment to the next, depending upon the kind of food composition being produced. However, typically, the second period of time is less than the first period of time. This may range from the second period being slightly less. In the example cited above, if the cook is for one hour, the first period could be 31 minutes and the second period for 29 minutes. The first and second periods could of course be longer such as 40 minutes and 20 minutes, respectively.

Where first and second periods of time are used, the ratio of the first period of time to second period of time can vary widely. Preferably the ratio of the first period of time to second period is in the range of greater than about 5:4, more preferably in the range of about 2:1 to about 6:1, and more preferably about 3:1. For one example, in an embodiment having a total combined first and second periods of times equaling about 45 minutes, it is most preferable for the first period of time to be about 33.37 minutes, and the second period of time to be about 11.25 minutes (i.e.: a ratio of about 3:1).

The mixing speeds during either the first or the second periods of time can vary widely, depending upon the kind of food composition being produced. Mixing speeds generally known in the art for making the particular type of food composition can be used. In some preferred embodiments, the mixing speeds during the first and second time periods can be the same or different, and can range from to about 10 to about 400 revolutions per minute (RPM), more preferably in the range of about 30 to about 200 RPM, and most preferably in the range of about 40 to about 150 RPM.

The intermediate of the present invention may be cooked during one or both of the first and second periods of time and can vary widely, depending upon the kind of food product being produced. In some preferred embodiments, the cook temperatures during the first and second time periods can be the same or different, and can range from just above ambient temperature to about 300° C., more preferably in the range of about 50° C. to about 200°, and most preferably in the range of 80° C. to about 120° C.

After the first period of time is complete, the intermediate dough is formed during the cook. Thereafter, the concentrated source of beta glucan, preferably in a powder, is added to the intermediate dough. Typically, the beta glucan is added without interrupting the mixing/cooking, by for example, the lid of the mixer/cooker can be opened, and concentrate powder is added during mixing/cooking after the first period of time. The beta glucan is generally added over a short period of time. For example, it can take from about 1 second to about 10 minutes to add the entire amount of beta glucan, but more preferably the addition occurs within a time period of about 5 seconds to about 60 seconds.

During and after the addition of the beta glucan, the dough is mixed and cooked for a second period of time. The second period of time is preferably in the range of about 1 minute, to about 20 minutes. The mixing during the second period of time is preferably set to between about 80 and about 120 RPM, and preferably about 100 RPM. The cook temperature during the second period of time within the mixer/cooker is set between about 90° C. and about 100° C., preferably between about 94° C. and about 97° C., and more preferably at about 95° C.

The resulting dough can be used as a final food product, or can thereafter be processed into a final food product. For example, the dough can be extruded, molded, shaped, formed, cut, and the like into desired shapes and sizes, and further cooked, baked, puffed, fried, and the like to produce finished food products.

In some embodiments, the resulting dough can be processed through extrusion, for example, through a press having various dies or slots for the extrudate, and the resulting pellets can be dried and puffed. In other embodiments, the process may include cooking forming and puffing procedures. In still other embodiments, the processing can include forming and baking.

The method of the invention could be used in the production of any generally known food composition wherein the addition of beta glucan would be appropriate, and the processability of the food composition due to the addition of the beta glucan is of concern. The invention is in no way limited to the particular ingredients of the food compositions described, or the particular processing of the food compositions.

The effect of the time of addition of the beta-glucan on the attributes of the dough was investigated and in that regard, four separate dough formulations were made using four different times of addition of the beta glucan and are set forth in Table 2, below. The ingredients for each of the doughs included oat flour, wheat starch, sugar, salt, calcium carbonate, cornstarch, oat fiber, beta glucan concentrate, with 20 ml of water being utilized.

The dry ingredients, less the beta-glucan concentrate, were put into a Brabender Plasticorder. The ingredients were mixed and cooked for approximately 45 minutes.

Initially, in each formulation, the dry ingredients were added, mixing was begun, and water was added. The mixing rpm was set to 100 and the temperature was set to 96.2° C. The only difference between all of the formulations is that the beta-glucan concentrate was added at varying time intervals, as is shown in the Table 2 below.

Part of each dough formulation was then frozen for characterizing viscosity. The resulting torque of each of the four dough formulations are given below in Table 2. The remainder of the dough was extruded, and the resulting pellets were dried (212° F., 1 hr) and puffed.

TABLE 2

| | Time of | Mix time | | |
|---|---|---|---|---|
| | start of | after start | | |
| | addition | of addition | Torque (std. | |
| Dough | of beta | of beta | Dough | |
| Formulation | glucan | glucan | mixture = | Dough |
| Number | (minutes) | (minutes) | 38-41) | Attributes |
| Formulation 1 | 0* | 45.0 | | wet and sticky |
| Formulation 2 | 11.25 | 33.75 | | wet and sticky |
| Formulation 3 | 22.5 | 22.5 | 34-35 | wet |
| Formulation 4 | 33.75 | 11.25 | 44-45 | looked and acted |
| | | | | normal dough |

The above results show that the optimal method of adding the beta-glucan was to add the concentrate after 33.75 minutes of a 45-minute mixing/cooking process, as shown in formulation 4. In formulation 4, at the 33.75-minute mark of the 45-minute mixing/cooking, the concentrated source of beta glucan powder was added during mixing. The addition was done by minute 34. The last 11 minutes were mixed at 100 rpm at a temperature averaging 95° C. (set point 96.2° C.). The standard torque during mixing is generally 43; during the experimental run in formulation 4 with addition of the beta glucan concentrate, the torque increased to 44-45.

Having developed a method of adding beta glucan that produces a useable dough, the next step was to determine whether or not a concentration of 3 gm of beta glucan could be delivered in a 30 gm serving size of an oat-based RTE cereal.

The dough was mixed/cooked at 95° C. for 45 minutes and the beta glucan added as in the previous example. The dough was then removed from the mixer/cooker and palletized. The pellets were dried for 60 min at 212° F. The puff procedure involved heating at 500° F. for 25 seconds.

It will thus be seen according to the present invention a highly advantageous food intermediate has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products

1. A method of preparing a food intermediate, the method comprising:
providing a first group of ingredients in a first state;
forming a first food intermediate by combining said first group of ingredients and hydrating said ingredients;
mixing said ingredients for a first period of time to provide said first food intermediate with a second state different than said first state;
adding a concentrated source of beta glucan to said first food intermediate to create a second food intermediate distinct from said first intermediate;
mixing said second food intermediate for a second period of time, less than said first period of time to complete said second intermediate; and
processing said second intermediate to create a third intermediate.

2. The method of claim 1, wherein said concentrated source of beta glucan comprises at least 15% by wt. beta glucan.

3. The method of claim 1, wherein the weight percent of beta glucan in said second food intermediate ranges from about 5 wt. % to about 25 wt. %.

4. The method of claim 1, wherein said first period of time is slightly more than said second period of time.

5. The method of claim 1, wherein the step of forming food intermediate further includes the further step of cooking the combined ingredients for at least a portion of said first period of time.

6. The method of claim 1, includes the further step of cooking the food intermediate during at least a portion of the second period of time.

7. The method of claim 1, wherein the processing step includes extruding said third intermediate.

8. The method of claim 1, wherein the processing step includes puffing said third intermediate.

9. The method of claim 1, wherein the processing step includes rolling said third intermediate.

10. The method of claim 1, comprising the further step of mixing macronutrients and micronutrients with said second intermediate to create a nutritionally complete food product.

11. A method of preparing a food intermediate having increased levels of dietary fiber, comprising the steps of;
Providing a first group of ingredients;
Mixing said first group of ingredients for a first period of time to produce a first food intermediate;
Adding a concentrated source of dietary fiber; and
Mixing said first intermediate with said concentrated source of dietary fiber for a second period of time to produce a second intermediate and wherein said second period of time is less than said first period of time.

12. A method of preparing a food intermediate having increased levels of dietary fiber as recited in claim 11, wherein said concentrated source of dietary fiber is beta glucan.

13. A method of preparing a food intermediate having increased levels of dietary fiber as recited in claim 12, wherein said beta glucan is provided in a purified form of at least 15% by weight.

14. The method of preparing a food intermediate having increased levels of dietary fiber as recited in claim 12, wherein the weight percent of beta glucan in said second food intermediate ranges from about 5 wt. % to about 25 wt. %.

15. The method of preparing a food intermediate having increased levels of dietary fiber as recited in claim 11, comprising the further step of mixing at least one of said first and second intermediates with micronutrients and macronutrients.

16. The method of preparing a food intermediate having increased levels of dietary fiber as recited in claim 11, wherein a ratio between said first period of time to said second period of time is approximately 3 to 1.

17. A food intermediate formed from at least two distinct mixing steps, comprising;
a first group of ingredients mixed for a first period of time to form a first food intermediate having a first texture;
a concentrated source of beta glucan mixed with said first food intermediate during a second period of time, less than said first period of time to create a second food intermediate; and
said second food intermediate having a texture distinct from said first texture and said second food intermediate having greater than 5% by weight of beta glucan obtained from said concentrated source of beta glucan.

18. A food intermediate as recited in claim 18, wherein said concentrated source of beta glucan includes about 5 to 25% by weight of beta glucan.

19. A food intermediate as recited in claim 18, wherein said food intermediate is used to produce a ready to eat food product.

20. A food intermediate as recited in claim 18, wherein said food intermediate is a grain based dough.
